(19) United States
(12) Patent Application Publication
(10) Pub. No.: US 2025/0084774 A1
(43) Pub. Date: Mar. 13, 2025

(54) HEAT RECOVERY IN A LNG PLANT

(71) Applicant: Nuovo Pignone Tecnologie - S.r.l., Florence (IT)

(72) Inventors: Olaf STALLMANN, Frankfurt, Hesse (DE); Simone AMIDEI, Florence (IT)

(21) Appl. No.: 18/292,436

(22) PCT Filed: Jul. 27, 2022
(86) PCT No.: PCT/EP2022/025357

§ 371 Date: Jan. 26, 2024

(30) Foreign Application Priority Data
Aug. 2, 2021 (IT) 102021000020756

(51) Int. Cl. F01K 23/10; F25J 1/00; F25J 1/02

(52) U.S. Cl. CPC F01K 23/10; F25J 1/0022; F25J 1/0243; F25J 2240/70; F25J 2240/82

(57) ABSTRACT

In the LNG plant, heat is provided to natural a gas processing system, including a pre-treatment unit and/or a liquefaction unit and/or an evaporation unit, by exploiting heat recovered through a steam generator of the plant that is thermally coupled to an exhaust outlet of a gas turbine of the plant. A heat transfer fluid circuit system with a circulating heat transfer fluid includes a first portion and a second portion; the first portion is located in a section of the steam generator to extract heat from to exhaust gases; the section is located between a stack and an evaporation section; the second portion is thermally coupled to the gas processing system so to provide heat thereto for example through an heat exchanger.

### TECHNICAL FIELD

The subject-matter disclosed herein relates to a LNG plant with heat transfer fluid circuit system for recovery of heat from a steam generator in the plant.

### BACKGROUND ART

For reasons such as the desire to reduce carbon dioxide emissions, the consumption of natural gas has been increased during the last years and will substantially grow in the coming years. Thus, it becomes relevant that Liquefied Natural Gas (LNG) plants improve the thermal efficiency of their machines and the overall efficiency of the plant.

LNG plants require a large amount of power and typically gas turbines are used to provide it. However, LNG plants also produce a non-negligible amount of waste heat that can be leveraged by implementing Waste Heat Recovery Units (WHRU) to recover heat that can return back into the LNG plant. In some cases, the waste heat from exhaust gases of the gas turbine can be used to generate electric power through a Heat Recovery Steam Generator (HRSG) that generates a steam flow that is expanded in a steam turbine. This design is known as Combined Cycle (=CC) configuration.

In LNG plants there are also one or more heat consumers which require heat at a moderate to low temperature. In order to reduce plant costs and to improve plant efficiency, in prior-art LNG plants with CC design, steam extraction from a steam turbine is performed to provide heat to the one or more heat consumers; usually, a heat transfer fluid circuit circulating the extracted steam is provided. FIG. 1 shows schematically a prior-art LNG plant 100 with CC design comprising a gas turbine 20, a steam turbine 30 and a steam generator 40; the steam generator 40 is thermally coupled to an exhaust outlet 24 of the gas turbine 20 and arranged to feed steam to a steam inlet 32 of the steam turbine 30; the steam turbine 30 has a first steam outlet 70 dedicated to steam extraction and a second steam outlet 33 configured to return back steam to the steam generator 40. In FIG. 1, steam generator 40 has four coil sections 45, 46, 47, 48 located downstream the exhaust outlet 24 and thermally coupled to the exhaust outlet 24. The combination of coil sections 45, 46, 47, 48 is configured to convert water to steam: typically the first section 45 downstream the exhaust outlet is known as “superheater”, the second section 46 is known as “re-heater”, the third section 47 is known as “evaporator” and the fourth section 48 is known as “economizer”.

Due to the risk of leakage of hydrocarbon from the LNG plant to the steam extracted from the steam turbine, this steam cannot be directly used to transfer heat to the heat consumer(s) of the LNG plant. Therefore, a heating unit comprising a transfer heat circuit 10 including a heating medium is provided to transfer heat to an heat consumer 60 of the LNG plant 100 as shown in FIG. 1. The heating unit comprises at least a pump 72 and two exchangers 71 and 73 (one receiving heat from the extracted steam to heat the heating medium and the other one cooling down the heating medium by transferring heat to the heat consumer 60).

However, a system like for example the one shown in FIG. 1 is an expensive solution because it implements two heat transfer fluid circuits and includes several heat exchangers and several pumps in the circuits. Moreover, the control of the whole system is complicated and sometimes may result in operational problems, for example due to steam extraction failures. Finally, extracted steam results in a loss of power in the downstream stages of the turbine, affecting turbine efficiency.

### SUMMARY

Therefore, it would be desirable to have a combined cycle LNG plant wherein the heat demand of heat consumers is met by heat recovery without extraction of fluid, in particular without extraction of steam from the steam turbine, in order to reduce the complexity, in particular the number of heat exchanger, and to increase the degree of flexibility of the plant.

According to an aspect, the subject-matter disclosed herein relates to a LNG plant having a gas turbine and a steam turbine in combined cycle (=CC) configuration, the gas turbine and the steam turbine being thermally coupled through a heat recovery steam generator (=HRSG). The LNG plant comprises further a heat transfer fluid circuit system partially integrated in the HRSG and partially located between the stack and the evaporator section of the HRSG; the heat transfer fluid circuit system with a heat transfer fluid circuit is configured to recover heat from the HRSG and to provide heat to a natural gas processing system of the LNG plant. Advantageously, the heat transfer fluid circuit is configured to circulate oil and is thermally coupled to an exhaust outlet of the gas turbine so to extract heat from the exhaust outlet and is thermally coupled to the natural gas processing system to transfer at least some of said heat to the natural gas processing system through at least an heat exchanger.

### BRIEF DESCRIPTION OF THE DRAWINGS

A more complete appreciation of the disclosed embodiments of the invention and many of the attendant advantages thereof will be readily obtained as the same becomes better understood by reference to the following detailed description when considered in connection with the accompanying drawings, wherein:

FIG. 1 shows a schematic diagram of a prior-art LNG plant with CC design recovering heat by steam extraction from steam turbine,

FIG. 2 shows a schematic diagram of a first embodiment of an innovative LNG plant with CC design recovering heat from a heat recovery steam generator and providing heat to a natural gas pre-treatment unit,

FIG. 3 shows a detail of the heat transfer fluid circuit system of the first embodiment of FIG. 2,

FIG. 4 shows a schematic diagram of a second embodiment of an innovative LNG plant with CC design recovering heat from a heat recovery steam generator and providing heat to a natural gas pre-treatment unit and to a natural gas liquefaction unit, and

FIG. 5 shows a detail of the heat transfer fluid circuit system of the second embodiment of FIG. 4.

### DETAILED DESCRIPTION OF EMBODIMENTS

The subject matter disclosed herein relates to innovative LNG plants which have a heat transfer fluid circuit system with a heat transfer fluid circuit. The heat transfer circuit is thermally coupled to an exhaust outlet of a gas turbine of the LNG plant, so to extract heat directly from the exhaust outlet; the heat transfer fluid circuit is then configured to transfer at least some of said heat directly to the natural gas processing system of the LNG through a heat exchanger. This is indeed a simple and effective solution.

Reference will now be made in detail to embodiments of the disclosure, two examples of which are illustrated in the drawings. Each example is provided by way of explanation of the disclosure, not limitation of the disclosure. In fact, it will be apparent to those skilled in the art that various modifications and variations can be made in the present disclosure without departing from the scope or spirit of the disclosure.

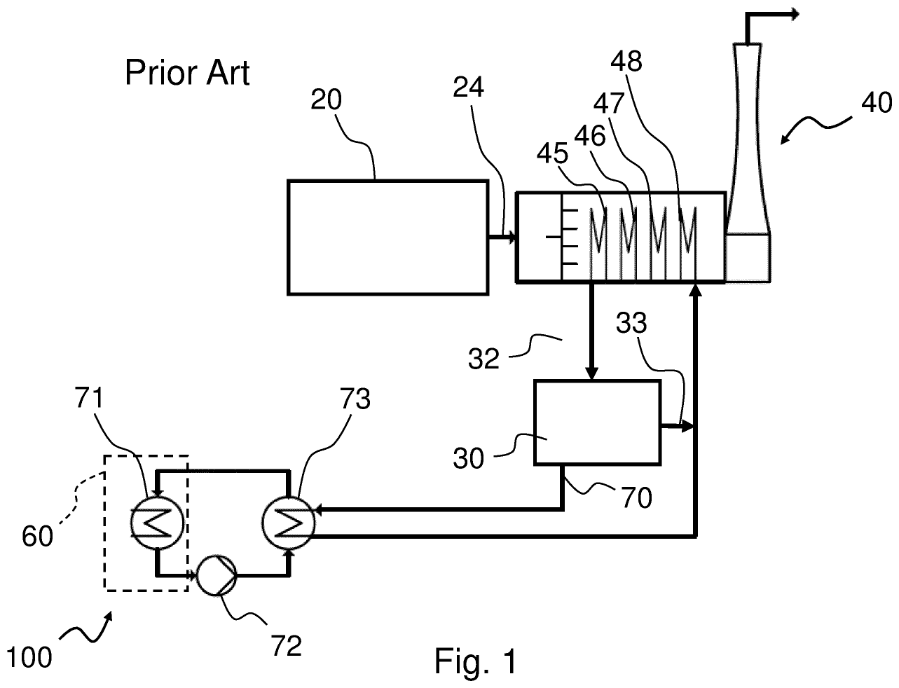

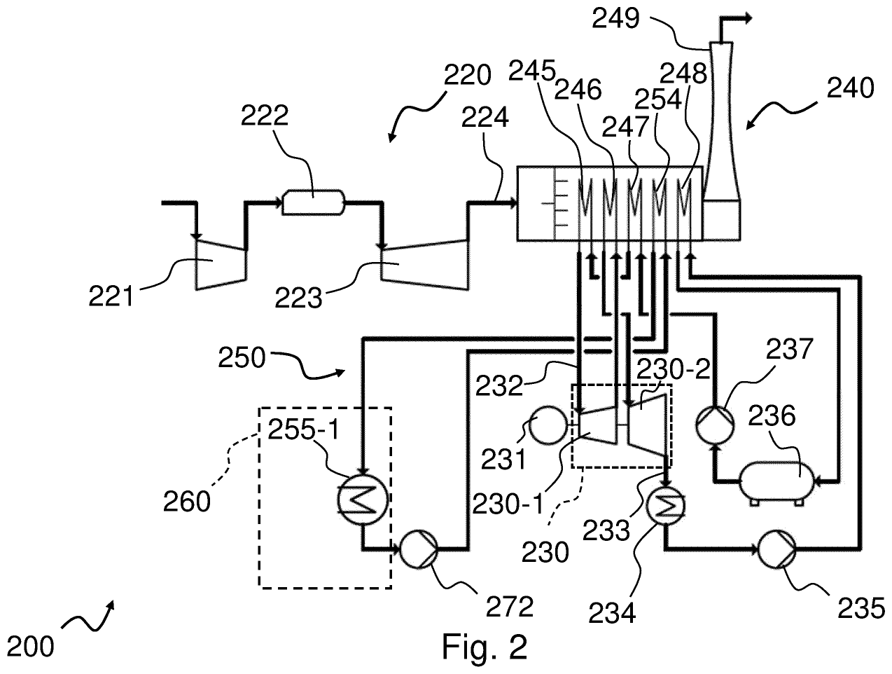

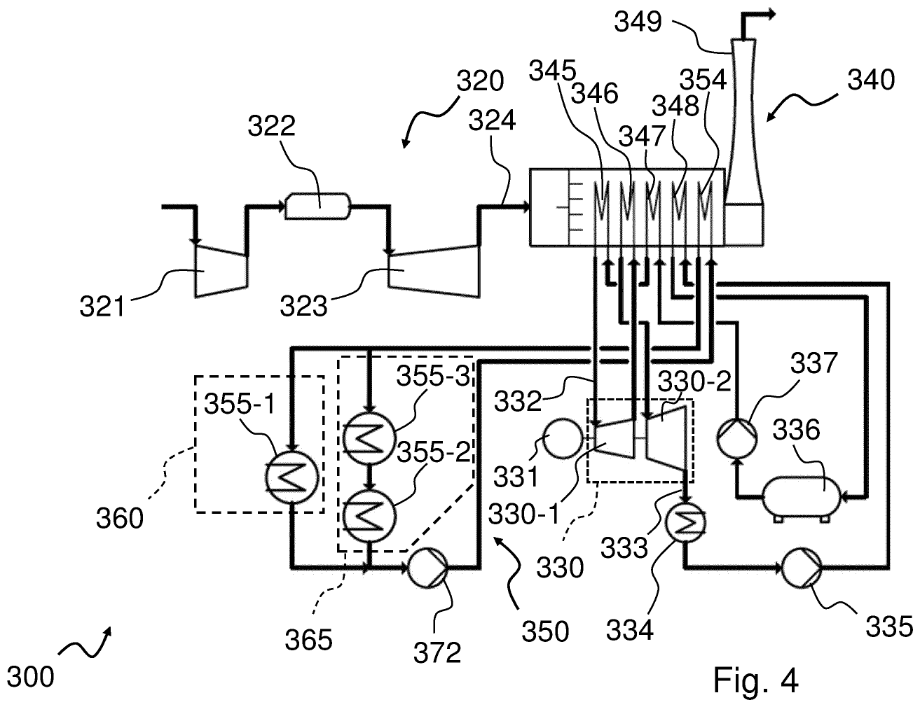

Referring now to the drawings, FIG. 1 is a schematic diagram of a known LNG plant 100, FIG. 2 and FIG. 4 are respectively schematic diagrams of a first embodiment and a second embodiment of an innovative LNG plant.

Innovative LNG plants essentially differ from the prior-art LNG plant 100 of FIG. 1 in that heat to be provided to a heat consumer may be recovered directly from an exhaust outlet of a gas turbine of the LNG plant, thus without the need to have steam extraction from the steam turbine like of the LNG plant. In particular, innovative LNG plants comprise a heat transfer fluid circuit system with a heat transfer fluid which may exploit heat from the exhaust outlet of the gas turbine and transfer it directly to a natural gas processing system through at least one heat exchanger, the natural gas processing system including one or more heat consumers, for example a liquefaction unit (in LNG plants designed for gas-liquid transformation of natural gas) or a evaporation unit (in LNG plants designed for liquid-gas transformation of natural gas). It is to be noted that the expression “natural gas” refers to the substance and is often used independently on the status of the substance, i.e. gas state or liquid state.

It is to be clarified that FIG. 2 and FIG. 4 and their relationship with FIG. 1 should not be construed restrictively. Many other embodiments are possible for example with different heat transfer fluid circuit system arrangements and/or different number of heat exchangers and/or different heat exchangers arrangements.

FIG. 2 schematically shows, for example and without limitation, a first embodiment of as innovative LNG plant generally indicated with reference numeral 200. According to this embodiment, LNG plant 200 comprises a gas turbine 220, a steam turbine 230 and a steam generator 240. As it will be apparent from the following, heat from the gas turbine 220 may be recovered by the steam generator 240, in particular a heat recovery steam generator (=HRSG). Heat recovery steam generator 240 is configured to convert inlet water to steam by transferring heat from the gas turbine 220 to the inlet water; in particular, heat recovery steam generator 240 is configured to feed the steam to the steam turbine 230 in a conventional combined cycle (=CC) configuration.

With non-limiting reference to FIG. 2, gas turbine 220 of LNG plant 200 is configured to perform a combustion of air and fuel, and to expand the combustion products, typically to generate electric power. The expansion of combustion products generates exhaust gases at an outlet of the gas turbine 220. Typically, gas turbine 220 essentially comprises:
a compressor 221, configured to compress inlet air,
a combustor 222, configured to receive a fuel and the compressed air from the compressor 221 and to perform a combustion, generating combustion products,
a turbine 223, configured to expand combustion products received from the combustor 222 and to generate exhaust gases having a temperature in generally in the range of 800-2100 degrees; typically, the turbine 223 is coupled with an electric generator 21 to generate electric power.

Gas turbine 220, in particular the turbine 223, has an exhaust outlet 224 thermally coupled to the steam generator 240. Typically, exhaust gases discharged by the exhaust outlet 224 still have heat capacity which can be advantageously exploited by the steam generator 240, in particular by a heat recovery steam generator (=HRSG). In other words, the steam generator 240 may still extract heat from hot exhaust gases discharged by the exhaust outlet 224 of the gas turbine.

Steam generator 240 may have an evaporator section 247, for example including coils, configured to convert water to steam by heating the water flowing inside the evaporator section 247; the heat used to heat the water flowing inside the evaporator section 247 may be part of the heat extracted by the steam generator 240 from exhaust gases of the gas turbine 220. Steam generator 240 in FIG. 2 is similar to steam generator 40 in FIG. 1; by comparing the two figures, it is apparent that steam generator 240 has one coil section more than steam generator 40. The number of coil sections and their configuration may vary from embodiment to embodiment; however, the steam generator of the embodiment has at least one “evaporator” section to perform phase change (from water to steam) of the water flowing inside the evaporator section.

With non-limiting reference to FIG. 2, steam generator 240 is configured to feed the steam to the steam turbine 230, in particular to a steam inlet 232 of the steam turbine 230. Advantageously, steam turbine 230 is configured to expand the steam received from the steam generator 240; typically, the steam turbine 230 is coupled with an electric generator 231 to generate electric power. It is to be noted that the steam turbine 230 may be divided into one or more turbine sections. For example, in FIG. 2, two turbine sections 230-1 and 230-2 are represented: the first turbine section 230-1 expands high-pressure steam and the second turbine section expands low-pressure steam.

Advantageously, the steam turbine 230 has a steam outlet 233 coupled with a condenser 234, the condenser 234 being arranged to condense the steam discharged from the steam outlet 233 to water; advantageously, the water is pumped by a first pump 235 to a first section of the steam generator 240, for example to the “economizer” section 248 of the steam generator 240. The “economizer” section 248 is configured to transfer a first part of the heat recovered from the exhaust gases discharged by the exhaust outlet 224 of the gas turbine to the water. Advantageously, after passing through the “economizer” section 248, the water then passes through a deaerator 236 in order to remove dissolved gases in water, in particular oxygen. Downstream the deaerator 236, the water is pumped by a second pump 237 firstly to a second section of the steam generator 240, for example to the “evaporator” section 247 of the steam generator 240 and then to a fourth section of the steam generator 240, for example to the “superheater” section 245 of the steam generator 240. The “evaporator” section 247 is configured to transfer a second part of the heat recovered from the exhaust gases discharged by the exhaust outlet 224 to the water, in order to perform phase change (from water to steam) of the water flowing inside the evaporator section 247. The “superheater” section 245 is configured to transfer a fourth part of the heat from the exhaust gases discharged by the exhaust outlet 224 to the steam flowing in the “superheater” section 245. It is to be noted that, after passing through the “superheater” section 245, the steam is fed to the steam turbine 230, in particular to a steam inlet 232 of the steam turbine 230.

It is also to be noted that if steam turbine 230 has more than one turbine section, for example two turbine sections 230-1 and 230-2 as shown in FIG. 2, the steam at the outlet of the first turbine section 230-1 may be passed through a third section of the steam generator 240, for example to the “re-heater” section 246 of the steam generator 240. The “re-heater” section 246 is configured to transfer a third part of the heat from the exhaust gases discharged by the exhaust outlet 224 to the steam flowing in the “re-heater” section 246. It is to be noted that, after passing through the “re-heater” section 246, the steam is fed to the second turbine section 230-2, in order to continue the steam expansion and then being discharged from the steam outlet 233.

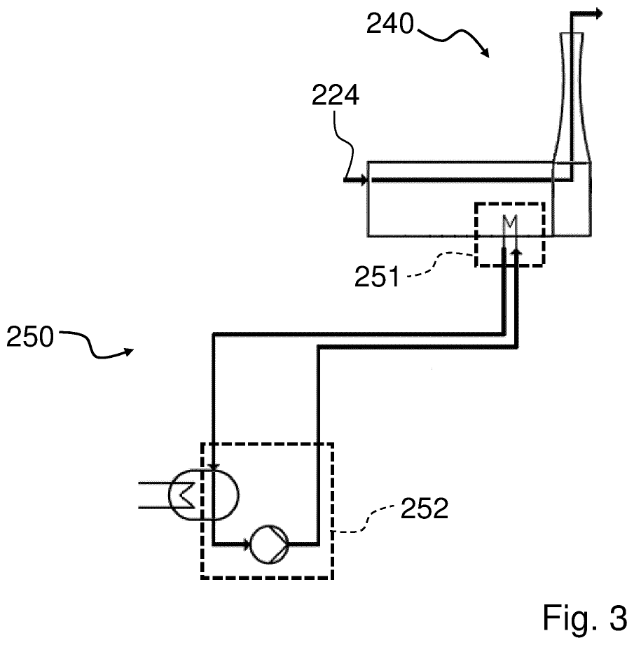

With non-limiting reference to FIG. 2 and FIG. 3, LNG plant 200 comprises further a heat transfer fluid circuit system 250 comprising at least a first circuit portion 251 and a second circuit portion 252 fluidly coupled between each other. The first circuit portion 251 is thermally coupled to the exhaust outlet 224, in particular to exhaust gases of the gas turbine 220 to extract heat therefrom; in particular, the first circuit portion 251 is located in a section of the steam generator 240. The second circuit portion 252 is thermally coupled to a natural gas processing system 260 to transfer at least some of the heat extracted from exhaust gases of the gas turbine 220 to the natural gas processing system 260. Advantageously, the natural gas processing system 260 comprises a natural gas pre-treatment unit. Advantageously, the natural gas pre-treatment unit comprises an acid gas removal unit and/or a regeneration gas heater or preheater unit of the LNG plant 200; typically, these units require heat to work, so they may also be called “heat consumers”. Advantageously, embodiments of the innovative LNG plant 200 may recover heat from the exhaust gas of the steam turbine 220 to provide heat to these natural gas pre-treatment, acid gas removal, regeneration gas heater, and/or pre-heater units, as it will be apparent from the following.

The heat transfer fluid circuit system 250 is configured to circulate a heat transfer fluid; according to some advantageous embodiments, the heat transfer fluid is an oil (or oil mixture) suitably selected for its favorable heat absorption and/or heat storage properties. One example commercially available, by way of illustration, is Therminol 59. Advantageously, the oil is selected also according to the expected operating conditions in the HRSG where the heat transfer fluid circuit is located. For example, the oil may be selected to minimize the coke formation from high temperature induced pyrolysis. For this reason, advantageously, oil candidates have excellent thermal stability within their expected temperature ranges of up to 380° C. Advantageously, the heat transfer fluid circuit system 250 comprises a pump 272 configured to move the heat transfer fluid along the heat transfer fluid circuit system 250. As explained above, the heat transfer fluid circuit system 250 of FIG. 2 has a first circuit portion 251 and a second circuit portion 252. Advantageously, the first circuit portion 251 and the second circuit portion are directly fluidly coupled together, so that the amount of heat transfer fluid that circulates in the first circuit portion 251 is substantially the same that circulates in the second circuit portion 252.

The first circuit portion 251 comprises a coil 254 located in a section of the steam generator 240; alternatively, there may be more than one coil of the inventive fluid circuit system located in a section of the steam generator. Advantageously, the coil 254 is configured to transfer heat to the heat transfer fluid that circulates in the heat transfer fluid circuit system 250. In particular, the coil 254 is configured to transfer part of the heat of the exhaust gases, usually between 20%-60%, from the exhaust gases discharged by the exhaust outlet 224 of the gas turbine 220; so, part of the heat flows from the exhaust gases flowing in the steam generator 240 to the heat transfer fluid flowing in the coil 254. Of course, higher percentages of heat transfer are easily possible, for example from 60% to 100%, but may cause poor performance of the steam cycle, reducing therefore the efficiency of the steam cycle.

With non-limiting reference to FIG. 2, the coil 254 is located in a section of the steam generator 240 between a stack 249 and the “evaporator” section 247. It is to be noted that the stack 249 is the section of the steam generator 240 at which the exhaust gases flowing in the steam generator 240 are discharged to atmosphere (they may be discharged directly after previous heating sections of steam generator 240—such as “evaporator” section 254 or “economizer” section 248—or after exhaust gases cleaning systems). Advantageously, coil 254 of the first circuit portion 251 may leverage heat recovered from exhaust gases at temperature levels that are not used by the steam generator 240 to convert water to steam; in other words, coil 254 may leverage heat from exhaust gases at temperature levels which are different from temperature levels used by the heating sections 245, 246, 247, 248 of the steam generator 240.

Alternatively or additionally, between the “evaporator” section 247 and the stack 249 there may be other steam generator coils or sections, located upstream or downstream coil 250. Alternatively, in some embodiments, coil or coils of the inventive fluid circuit system may be at least partially overlapped to steam generator coils or sections located between the “evaporator” section 247 and the stack 249. For example, coil or coils may be overlapped partially or totally to the “economizer” section 248 of the steam generator 240.

According to preferred embodiments, the first circuit portion 251 is located and configured so that a temperature of the heat transfer fluid upstream the first circuit portion 251 is in a range of 40-50° C. and a temperature of the heat transfer fluid downstream the first circuit portion 251 is in a range of 170-300° C. Typically, temperature of exhaust gases discharged at the stack 249 is limited to 80-100° C., due to acid condensation of exhaust gases below these temperature with the risk of corrosion of material of steam generator 240; consequently, temperature of the heat transfer fluid downstream the first circuit portion 251 is higher than the temperature of exhaust gases discharged at the stack 249. In general, the coil or coils are arranged in the steam generator so to be at optimal position considering the temperature that is intended for the heat transfer fluid downstream the first circuit portion.

The temperature downstream the first circuit portion 251 may depend on the location of coil 254 in the steam generator 240 and/or on the evaporation temperature of water in “evaporator” section 247. For example, if coil 254 is directly located downstream the “evaporator” section 247, the temperature downstream the first circuit portion 251 may be around 300° C. Alternatively, if there are other coils or sections of the steam generator 240 between “evaporator” section 247 and coil 254, the temperature downstream the first circuit portion 251 may be around 170° C. It is to be noted that, if no temperature losses along the heat transfer fluid circuit system 250 are considered, the temperature downstream the first circuit portion 251 may be the same as the temperature upstream the second circuit portion 252.

With non-limiting reference to FIG. 2 and FIG. 3, the second circuit portion 252 comprises at least one heat exchanger 255-1 configured to provide recovered heat from the exhaust gases to the natural gas pre-treatment unit. Advantageously, the second circuit portion 252 may have a heat exchanger for each unit which is comprised in the natural pre-treatment unit, for example for each acid gas removal unit and/or regeneration gas heater or preheater unit. It is to be noted that, if no fluid losses along the heat transfer fluid circuit system 250 are considered, the heat transfer fluid which exits from the second circuit portion 252 is the same that enters in the first circuit portion 251.

Referring now to FIG. 4, it is shown a second embodiment of a LNG plant 300; components of LNG plant 300 corresponding to components of LNG plant 200 are identified by reference numbers differing by one hundred. It is to be noted that components of LNG plant 300 corresponding to components of LNG plant 200 may be identical or similar and/or may be configured to operate in a similar way and perform similarly.

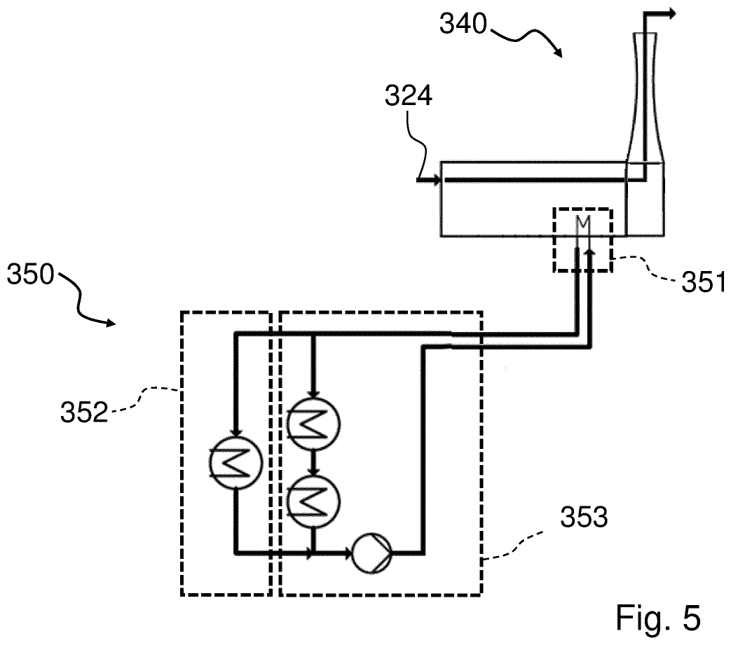

The embodiment of FIG. 4 and FIG. 5 is similar to the embodiment of FIG. 2 and FIG. 3 but it comprises further a third circuit portion 353 thermally coupled to a natural gas liquefaction unit 365 of a natural gas processing system to transfer at least some of the heat extracted from exhaust gases of the gas turbine 320 to the natural gas liquefaction unit 365. Advantageously, the third circuit portion 353 is coupled to the first circuit portion 351 of the heat transfer fluid circuit system 350; advantageously, the third circuit portion 353 is coupled to the second circuit portion 352 of the heat transfer fluid circuit system 350.

With non-limiting reference to FIG. 4 and FIG. 5, the second circuit portion 352 is thermally coupled to a natural gas pre-treatment unit 360 to provide heat thereto; in particular, the second circuit portion 352 comprises at least one heat exchanger 355-1 configured to provide heat to the natural gas pre-treatment unit 360. Advantageously, the second circuit portion 352 may have a heat exchanger for each unit which is comprised in the natural gas pre-treatment unit 360, for example for each acid gas removal unit and/or regeneration gas heater or preheater unit.

According but non-limiting to the embodiment of FIG. 4, the second circuit portion 352 comprises at least one heat exchanger 355-2 or 355-3 configured to provide heat to the natural gas liquefaction unit 365. Advantageously, the natural gas liquefaction unit 365 comprises a heavy hydrocarbon removal unit, for example a debutanizer reboiler and/or fractionation tower reboiler, and/or lube oil heater unit and/or other auxiliary heater units. Advantageously, the second circuit portion 352 may have a heat exchanger 355-2, 355-3 for each unit which is comprised in the natural gas liquefaction unit 365, for example for each heavy hydrocarbon removal unit, and/or lube oil heater unit and/or other auxiliary heater units.

With non-limiting reference to FIG. 4 and FIG. 5, the second circuit portion 352 and the third circuit portion 353 of the heat transfer fluid circuit system 350 are arranged in parallel configuration. In particular, inlets of both second circuit portion 352 and third circuit portion 353 are directly fluidly coupled to the outlet of first circuit portion 351 and outlets of both second circuit portion 352 and third circuit portion 353 are directly fluidly coupled to the inlet of first circuit portion 351. It is to be noted that first or second or third circuit portion may comprise a pump configured to move the heat transfer fluid.

In parallel configuration, a first amount of a total amount of heat transfer fluid circulating in the first circuit portion 351, circulates also in the second circuit portion 352 and a second amount of the total amount of heat transfer fluid circulating in the first circuit portion 351, circulates also in the third circuit portion 353. It is to be noted that the sum of the first amount and the second amount of the heat transfer fluid is the total amount of heat transfer fluid circulating in the first circuit portion 351. The first amount and the second amount of the heat transfer fluid circulating respectively in the second circuit portion 352 and in the third circuit portion 353 may be substantially equal or may be different.

Alternatively, the second circuit portion 352 and the third circuit portion 353 may be arranged in series configuration. For example, the second circuit portion 352 outlet may be directly fluidly coupled to the third circuit portion 353 inlet and the second circuit portion 352 inlet and third circuit portion 353 outlet may be both fluidly coupled respectively directly to the first circuit portion 351 outlet and directly to the first circuit portion 351 inlet. It is to be noted that the second circuit portion 352 and the third circuit portion 353 may be reversed; in particular, the third circuit portion 353 outlet may be coupled to the second circuit portion 352 inlet and the third circuit portion 353 inlet and second circuit portion 352 outlet may be both coupled respectively to the first circuit portion 351 outlet and to the first circuit portion 351 inlet. It is also to be noted that in series configuration, the total amount of heat transfer fluid circulating in the first circuit portion 351 is substantially the same amount of heat transfer fluid that circulates in the second circuit portion 351 and in the third circuit portion 353.

Referring to FIGS. 2 and 4, in operation, the gas turbine 220, 320 sucks air in the compressor 221, 321 and increases its pressure, so that compressed air is sent to the combustor 222, 322 and is burned with a fuel to generate combustion products; combustion products are then expanded in the turbine 223, 323 and exhaust gases are discharged at the exhaust outlet 224, 324 of the gas turbine 220, 320. Exhaust gases at the exhaust outlet 224, 324 still have thermal capacity which may be exploited by the steam generator 240, 340. Steam generator 240, 340 typically has one or more heat sections which comprises coils in which water flows; it is to be noted that the water which flows in coils may be in different phases (liquid, steam or liquid-vapor mixture). Steam generator 240, 340 is configured to convert water to steam by transferring heat from the exhaust gases to the water through coils, the steam being sent to a steam turbine 230, 330; finally, exhaust gases are discharged in atmosphere at the stack 249, 349 of the steam generator 240, 340. In the steam generator 240, 340 is partially located also the heat transfer fluid circuit system 250, 350 which comprises coil 254 located between the exhaust outlet 224, 324 and the stack 249, 349; coil 254 is configured to transfer heat from the exhaust gases to the heat transfer fluid that circulates in the heat transfer fluid circuit system 250, 350. The heat transfer fluid circuit system 250, 350 comprises also at least an heat exchanger 255-1, 355-1, 355-2, 355-3 which is thermally coupled to the natural gas processing system 260, 360, 365 in order to transfer at least some of the heat of the heat transfer fluid to the natural gas processing system.

In conclusion, LNG plants 200, 300 may recover heat from the exhaust gases discharged from the exhaust outlet 224, 234 of the gas turbine 220, 230. A system like for example the one shown in FIG. 2 or FIG. 4 allows a higher degree of flexibility of the LNG plant 200, 300, as the steam turbine 230, 330 and natural gas processing system 260, 360, 365 are decoupled, so they don't affect each others.

Moreover, it is important to notice that the LNG plant 200, 300 may leverage a source of heat (exhaust gases) that may be considered at “low energy level”, as it may extract heat from exhaust gases of gas turbine 220, 320 and it may supply said heat to natural gas processing system 260, 360, 365. In particular, the heat may be extracted by integrating a portion of a heat transfer fluid circuit system 250, 350 in a steam generator 240, 340 which is thermally coupled to the exhaust outlet of the gas turbine 220, 320.

On the contrary, prior-art LNG plants, like for example the one shown in FIG. 1, use steam extraction from the steam turbine to provide heat to natural gas processing system, wasting a source of heat (steam) that may be considered at “high energy level”. In fact, steam extraction results in a loss of amount of steam expanding in the steam turbine, resulting in a loss of power produced by the steam turbine.

Finally, providing heat to natural gas processing system by steam extraction from steam turbine according to prior-art LNG plants results also in a loss of heat in form of “lost work”, i.e. heat which is no longer available to do work. It is known that “lost work” is directly proportional to entropy of fluid used for performing heating and that the entropy is higher for a gas than for a liquid (at the same pressure). Therefore, heat losses of known LNG plants, like for example the one shown in FIG. 1 are higher than heat losses of innovative LNG plants, like for example the ones shown in FIG. 2 or in FIG. 4.

A heat transfer fluid circuit system as described herein may be installed on an existing LNG plant. Such system has a heat transfer fluid circuit which is configured to circulate a heat transfer fluid, advantageously an oil (or oil mixture). The heat transfer fluid circuit comprises at least a first circuit portion 251, 351 and a second circuit portion 252, 352 which is coupled with the first circuit portion 251, 351. The first circuit portion 251, 351 is configured to be thermally coupled to an exhaust outlet 224, 324 of the LNG plant, in order to extract heat from the exhaust outlet 224, 324. Advantageously, the first circuit portion 251, 351 is configured to be thermally coupled directly to the exhaust outlet 224, 324 of the LNG plant. More advantageously, the first circuit portion 251, 351 comprises coils 254, 354 which are configured to transfer heat from the hot exhaust gases discharged by the exhaust outlet 224, 324 to the heat transfer fluid circulating in the heat transfer fluid circuit. In particular, coils 254, 354 are located in a section of a steam generator 240, 340 of the LNG plant which is thermally coupled to the exhaust outlet 224, 324, so to extract heat from the hot exhaust gases discharged by the exhaust outlet 224, 324.

The second circuit portion 252, 352 is configured to be thermally coupled to a natural gas processing system 260, 360, 365 of the LNG plant in order to transfer at least some of the heat transferred to the heat transfer fluid to a natural gas processing system 260, 360, 365 of the LNG plant. Advantageously, the second circuit portion 252, 352 is configured to be thermally coupled directly to a natural gas processing system 260, 360, 365 of the LNG plant, in particular to a natural gas pre-treatment unit and/or a natural gas liquefaction unit.

1. A LNG plant comprising:
a natural gas processing system, a gas turbine having an exhaust outlet configured to discharge hot exhaust gases,
a steam turbine having a steam inlet, wherein the steam turbine is configured to expand steam,
a steam generator having an evaporator section configured to convert inlet water to steam by transferring heat to the inlet water, wherein said steam generator is thermally coupled to the exhaust outlet so to extract said heat from the hot exhaust gases discharged by the exhaust outlet and is configured to feed the steam to the steam inlet,
a heat transfer fluid circuit system with a heat transfer fluid circuit comprising at least a first circuit portion and a second circuit portion coupled with the first circuit portion,
wherein the heat transfer fluid circuit is configured to circulate a heat transfer fluid,
wherein the first circuit portion is thermally coupled to the exhaust outlet to extract said heat from the exhaust outlet,
wherein the second circuit portion is thermally coupled to the natural gas processing system to transfer at least some of said heat to the natural gas processing system,
wherein the first circuit portion comprises coil or coils located in a section of the steam generator and configured to transfer heat from the hot exhaust gases discharged by the exhaust outlet 224, 324 to the heat transfer fluid,
wherein the section of the steam generator is located between a stack and the evaporator section of the steam generator.

2. The LNG plant of claim 1, wherein the natural gas processing system comprises a natural gas pretreatment unit.

3. The LNG plant of claim 2, wherein the natural gas processing system comprises a natural gas liquefaction unit.

4. The LNG plant of claim 3, wherein the heat transfer fluid circuit further comprises,
a third circuit portion, wherein the second circuit portion is thermally coupled to the natural gas pre-treatment unit to provide heat thereto, wherein the third circuit portion is thermally coupled to the natural gas liquefaction unit to provide heat thereto.

5. The LNG plant of claim 1, wherein the natural gas processing system comprises a natural gas evaporation unit.

6. The LNG plant of claim 1, wherein the section of the steam generator where the coil/coils is/are arranged is located between the stack and the evaporator section; partially or totally overlapping with an economizer section of the steam generator.

7. The LNG plant of claim 1, wherein the first circuit portion is located and configured so that a temperature of the heat transfer fluid upstream the first circuit portion is in a range of 40-50° C. and a temperature of the heat transfer fluid downstream the first circuit portion is in a range of 170-300° C.

8. The LNG plant of claim 1, wherein the second circuit portion comprises at least one heat exchanger configured to provide heat to a natural gas pre-treatment unit or to a natural gas liquefaction unit.

9. The LNG plant of claim 4, wherein the third circuit portion comprises at least one heat exchanger configured to provide heat to the natural gas liquefaction unit.

10. The LNG plant of claim 2, wherein the natural gas pretreatment unit comprises an acid gas removal unit and/or a regeneration gas heater or preheater unit.

11. The LNG plant of claim 3, wherein the natural gas liquefaction unit comprises a heavy hydrocarbon removal unit, in particular a debutanizer reboiler and/or fractionation tower reboiler, and/or lube oil heater unit and/or other auxiliary heater units.

12. The LNG plant of claim 1, wherein the heat transfer fluid circuit is configured to circulate oil.

13. A heat transfer fluid circuit system for an LNG plant, with a heat transfer fluid circuit,
wherein the beat transfer fluid circuit is configured to circulate a heat transfer fluid and comprises at least:
a first circuit portion, and
a second circuit portion coupled with the first circuit portion;
wherein the first circuit portion is configured to be thermally coupled to an exhaust outlet of the LNG plant in order to extract heat from the exhaust outlet,
wherein the second circuit portion is configured to be thermally coupled to a natural gas processing system of the LNG plant in order to transfer at least some of said heat to a natural gas processing system of the LNG plant,
wherein the first circuit portion is configured to be thermally coupled directly to an exhaust outlet of the LNG plant and comprises coil or coils are configured to be located between a stack and a water evaporator section of a steam generator.

14. The system of claim 13, wherein the coil or coils are configured to be located between the stack and the water evaporator section, partially or totally overlapping with a water economizer section of the steam generator.

15. The system of claim 13, wherein the second circuit portion is configured to be thermally coupled directly to a natural gas processing system of the LNG plant.
